(19) United States
(12) Patent Application Publication
(10) Pub. No.: US 2006/0258328 A1
(43) Pub. Date: Nov. 16, 2006

(54) User defined codes for emergency calls

(75) Inventor: Mario Francisco Godoy, Elmhurst, IL (US)

Correspondence Address: JENNER & BLOCK LLP, ONE IBM PLAZA, CHICAGO, IL, 60611, US

(73) Assignee: Lucent Technologies Inc.

(21) Appl. No.: 11/126,607

(22) Filed: May 10, 2005

(51) Int. Cl. H04Q 7/20

(52) U.S. Cl. 455/404.1; 455/432.3; 455/433

(57) ABSTRACT

A user of a telecommunications device (112, 202), such as a telephone, wireless terminal, or the like, activates use of user codes for certain emergency calls. The user supplies the user codes to the telecommunication system for storage in a subscriber database (109, 212). Subsequently, if the user code is received by the telecommunications system from the user and this feature is activated, emergency treatment is applied to the call (400, 402, 406). For all other calls, traditional treatment is applied (404). Emergency treatment, which may be user defined, preferably includes: determining a location for the user using GPS (global positioning system) or other location determining systems; logging information related to the circumstances of the call, such as, subscriber number, time of call, day of call, serving base station or other pertinent information; monitoring and logging activity; connecting to other systems, such as police or emergency offices; routing calls to live operators, announcements, music or other audible sounds, including silence.

### FIELD OF THE INVENTION

The present invention relates generally to telecommunications systems, and in particular, to the use of user-defined codes for certain emergency calls.

### BACKGROUND OF THE INVENTION

The public telephone network is designed to provide, among other things, assistance to callers in emergency situations. The public telephone network has specialized switching equipment to route emergency calls to a regional center of operators who process the calls and initiate the dispatch of services needed in an emergency. Emergency calls are typically initiated by dialing a fixed or predefined number applicable to all emergency calls, 911 being the most popular example in the United States. After the emergency call is initiated, the call is routed to an operator who may connect the call to an emergency authority. The emergency authority handles the dispatch of emergency units such as the paramedics, police and firefighters. The operator typically remains on the call until the emergency authority tells the operator to release the call.

Using a fixed, predefined, general purpose code for all emergency calls is quite useful. However, there are certain times at which it would be desirable to have the ability to enter a number to solicit help in an emergency, yet not have that number be identifiable as a number used to solicit help. For example, in a situation where a victim is kidnapped, it would be desirable for the victim to alert others to the peril the victim faces, yet not have to actually communicate with operators and emergency authority personnel. Indeed, it would also be desirable for the victim in this situation to initiate a call without leaving traces indicating a predefined emergency number was called. In other words, the victim needs the capability to make a call for help, but conceal from others that a call for help has been attempted. No such capability presently exists.

Therefore, a need exists to enable a telecommunications system to permit callers to initiate emergency calls that are recognized by a telecommunications system, but are not readily detectable by others as emergency calls.

### SUMMARY OF THE INVENTION

The need is met and an advance in the art is made by the present invention, which permits the use of user-defined codes to initiate emergency calls.

According to the invention, a user of a telecommunications device, such as a telephone, wireless terminal, or the like, activates use of user codes for possible future use for certain emergency calls. The user supplies the user codes to the telecommunications system for storage in a subscriber database, i.e., a database that includes subscriber specific information. Subsequently, if the user code is received by the telecommunications system from the user and this feature is activated, emergency treatment is applied to the call. For all other calls, normal or traditional treatment, i.e., treatment other than emergency treatment in response to the user code, is applied. Emergency treatment, which may be user defined, preferably includes: determining a location for the user using GPS (global positioning system) or other location determining systems; logging information related to the circumstances of the call, such as, subscriber number, time of call, day of call, serving base station or other pertinent information; monitoring and logging activity; connecting to other systems, such as police or emergency offices; routing calls to live operators, announcements, music or other audible sounds, including silence.

Preferably, the system may be deactivated and false alarms can be indicated from the telecommunications device. Preferably, a mobile switching system or telephone switching system that permits user access to the telecommunication network is programmed to detect the activation of user defined emergency calls, to detect a user-defined emergency code by referencing a subscriber database, and to take appropriate action, i.e., initiate emergency treatment, according to options in the subscriber database or a default emergency treatment.

### BRIEF DESCRIPTION OF THE DRAWINGS

FIG. 1 is a block diagram of a preferred embodiment of a telephone switching system in accordance with the present invention.

FIG. 2 is a block diagram of a preferred embodiment of a wireless communications system in accordance with the present invention.

FIG. 3 is a flow chart illustrating a method for activating a user-defined emergency code in accordance with the present invention.

FIG. 4 is a flow chart illustrating a method for receiving and processing a user-defined emergency code in accordance with the present invention.

### DETAILED DESCRIPTION OF THE PREFERRED EMBODIMENTS

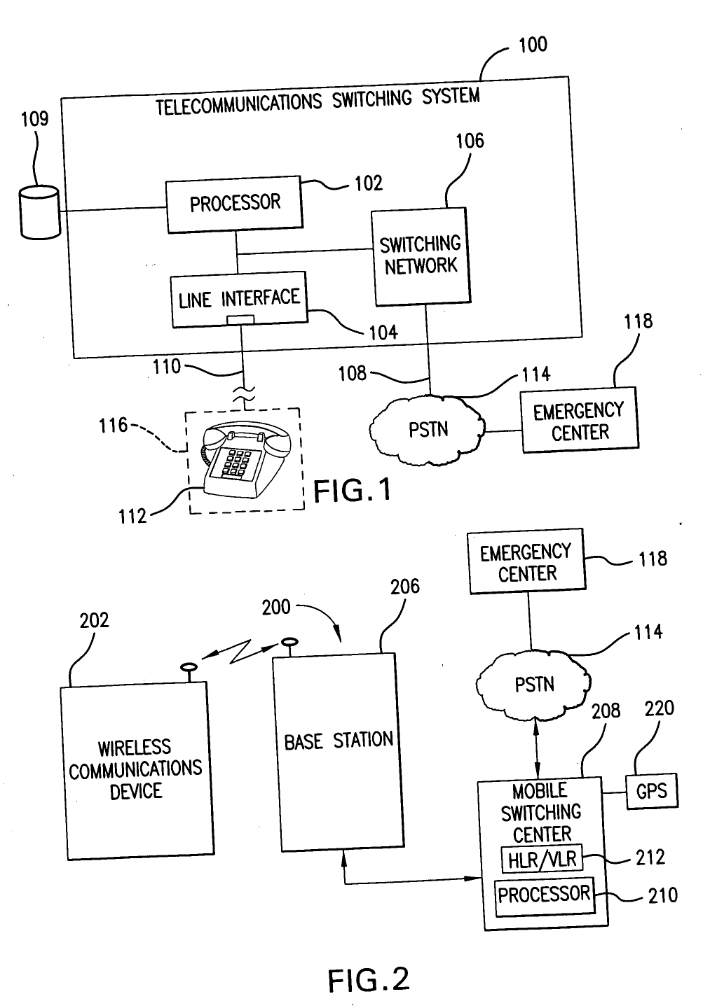

FIG. 1 is a block diagram of a telecommunications system in accordance with the present invention. The telecommunications system includes a telephone switching system 100. Telephone switching system 100 is programmable, including hardware and software components for operation. System 100 includes a processor 102, a line interface unit 104, switching network 106, trunk 108, and line 110. In a preferred embodiment, telephone switching system 100 is a 5ESS® switching system from Lucent Technologies Inc.

System 100 is coupled to a database 109 of subscriber information. Database 109 stores a user-defined code to signify an emergency in accordance with the present invention.

System 100 serves as an interface between customer premises equipment 112 and the public switched telephone network (PSTN) 114. An emergency center 118 is coupled for communication to the public switched telephone network 114 in order to receive and process emergency calls. Though emergency center 118 is shown in FIG. 1 as connected to the PSTN 114, this does not preclude emergency center 118 from being directly connected to system 100, as would be readily apparent to those skilled in the art. Customer premises equipment 112 is preferably a telephone. Customer premises equipment 112 is preferably used to supply a user-defined code that will signify an emergency in accordance with the present invention. Customer premise equipment 112 is also used to enter a user-defined code to signify an emergency and preferably cancel an emergency action in accordance with the present invention.

Processor 102 provides control over the functions of system 100. Though processor 102 is shown as a single processor block, processor 102 is alternatively, a single or multiple processors interconnected. Similarly, line interface unit 104 is shown as one block but may consist of multiple components or a single component capable of interfacing with multiple lines. In accordance with the present invention, processor 102 executes software code to perform functions in accordance with the present invention, as further specified below.

Line interface unit 104 interfaces line 110 with system 100. Line 110 is coupled to customer premises equipment 112, which is located on a customer's premises 116. Switching network 106 interfaces system 100 with PSTN 114. By virtue of switching network 106, customer premises equipment 112 is coupled to PSTN 114 for communications, including voice and data communications. Through PSTN 114 customer premises equipment 112 is coupled for communication to emergency center 118 in the case of an emergency in accordance with the present invention.

FIG. 2 is a block diagram of a wireless telecommunications system in accordance with the present invention. Wireless telecommunications system 200 includes wireless communications device 202, base station 206, mobile switching center (MSC) 208 and public switched telephone network (PSTN) 114. Wireless communications device 202 communicates with base station 206 over-the-air. Device 202 is preferably a wireless or cellular telephone, computer, personal digital assistant or the like. Device 202 is preferably used to supply a user-defined code that will signify an emergency in accordance with the present invention. Device 202 is also used to enter a user-defined code to signify an actual emergency and preferably to enter a user-defined code to cancel an emergency action in accordance with the present invention. Base station 206 extends communications from device 202 to MSC 208. Base station 206 is coupled to MSC 208 via data links.

MSC 208 is coupled to communicate with wireless communications device 202 over-the-air through base station 206. MSC 208 includes processor 210 for controlling the functions of MSC 208. Though processor 210 is shown as a single block, processor 210 is alternatively, a single or multiple processors interconnected. In accordance with the present invention, processor 210 preferably executes software code to perform functions in accordance with the present invention, as further specified below. MSC 208 interfaces to PSTN 114 for transmitting calls to and from the telephone network. MSC 208 includes a subscriber database 212, for example, a home location register or visitor location register, which stores subscriber specific data. Database 212 stores a user-defined code that is used to signify an emergency in accordance with the present invention. MSC 208 also may communicate with global positioning system 220 to determine a location of device 202. Through PSTN 114 emergency center 118 is coupled to device 202 for communications.

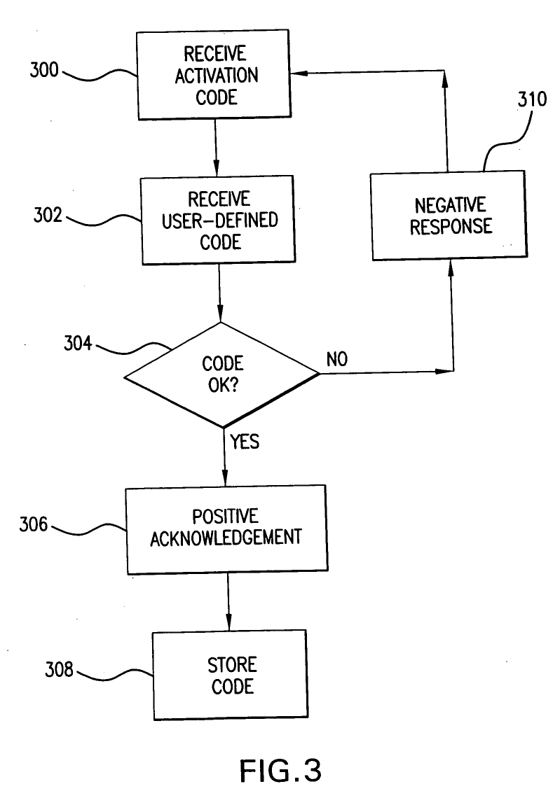

FIG. 3 is a flow chart illustrating a preferred method for activating a user-defined code for an emergency feature in accordance with the present invention. The method is described with reference to the embodiments shown in FIGS. 1 and 2. First, a user dials or selects, and the telecommunications system receives, a predetermined sequence of key digits, i.e., the activation code, to activate the emergency feature (300). This is accomplished by dialing or selecting the predetermined sequence of key digits on customer premises equipment 112 or on wireless communications device 202. Next, the user dials or selects, and the telecommunications system receives, the user-defined code (302). The user-defined code is preferably entered using customer premises equipment 112 or wireless communications device 202. Alternatively, the user-defined code and activation code are entered in any known manner for updating subscriber information, for example, by an operator or through the Internet. A processor, for example, processor 102 or processor 210, associated with the customer premise equipment 112 or device 202 receives the signals associated with the activation code and user-defined code. The processor, per a stored program, in response to receiving the activation code and the user-defined code, determines whether the user-defined code is acceptable (304). This preferably includes insuring that the user-defined code is not in use for some other feature, and that the subscriber is authorized to use the feature. This validity check may include accessing subscriber data and system data and comparing that data with the user-defined code. In some cases, the user-defined code may override an existing code.

If the user-defined code is acceptable (304), then a positive acknowledgement is supplied to the user (306). And, the user-defined code is stored, for example in database 109 or database 212 (308). The positive acknowledgement is preferably an audible tone or signal supplied to the user via customer premises equipment 112 or device 202. On the other hand, if the user-defined code is not acceptable (304), then a negative acknowledgement is supplied to the user via customer premises equipment 112 or device 202 (310). The negative acknowledgement is preferably an audible tone or signal supplied to the user via customer premises equipment 112 or device 202. The user-defined code is preferably a sequence of digits.

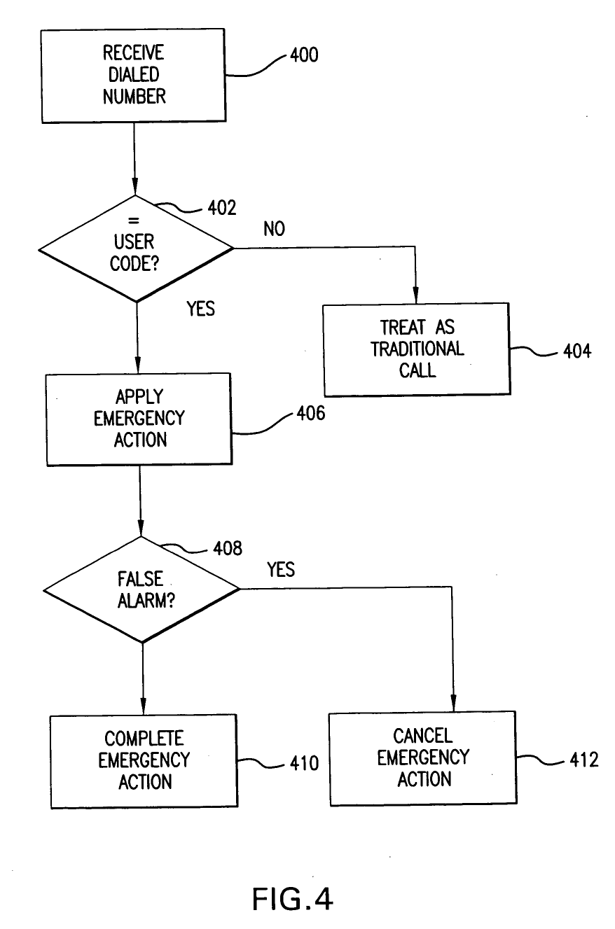

After the user-defined code is successfully stored, for example, by the method described above with respect to FIG. 3, then the user-defined emergency feature is ready for use. The user-defined emergency feature is utilized as described below with respect to FIG. 4.

A user may be faced with an emergency requiring use of the user-defined emergency feature under a number of circumstances. For example, in the case where a user is taken hostage, the user may want to alert others to her emergency situation, but not alert her captors that she has in fact made an emergency call. The present invention facilitates such a situation. In particular, the user may enter the user-defined code by selecting or dialing the user-defined code at customer premises equipment 112 or device 202. The telecommunications system receives the dialed code (400) and determines whether the dialed code is the same as the user-defined code (402). This requires obtaining the user-defined code that is stored in a subscriber database and comparing that code with the dialed number. If the user-defined code does not match the dialed number, then the call receives traditional treatment (404). On the other hand, if the user-defined code matches the dialed number (402), then emergency action is applied to the call (406).

The emergency action applied to the call may vary. In one embodiment, the emergency treatment is defined for the entire system and does not vary per subscriber. In other embodiments, the emergency action is customizable by the user, such parameters for customization being preferably stored in the subscriber database. The emergency action preferably includes coupling the call to an emergency center. Other emergency actions include initiating location tracking and logging, initiating e911 routing, routing the call to a pre-defined operator, routing the call to a pre-defined announcement, automatic notification of other pre-defined systems, providing no audible tone, recording a cell and sector and dropping the call. Where a location determination system, such as GPS system 220 is available, the location tracking preferably includes, recording, instantaneously and periodically, the subscriber identification, time and day of call, call type, and location data, such as x, y, z coordinates or serving base station.

In a preferred embodiment, a false alarm mechanism is provided to permit a user to indicate that an entered user-defined code was a false alarm, rather than an actual emergency. Where this mechanism is provided, the system preferably waits for the receipt of the false alarm code for a predetermined time after the user-defined emergency code is detected and emergency action is initiated (408). Alternatively, the system may proceed to take emergency action without delay, with the option to cancel actions in response to the false alarm code. If no false alarm code is received (408), then emergency action is completed (410). On the other hand, if a false alarm code is received (408), then emergency action is canceled and notifications are made commensurate with the emergency actions taken (412). For example, if the emergency action (406), included notification of an operator, then that operator is notified of the cancellation. Similarly, if location logging was initiated, then logging is stopped in response to receipt of the false alarm code. The false alarm code is preferably a sequence of digits that is user-defined. Most preferably, the false alarm code and any other customizable emergency actions are entered by the user and received by the system during activation of the features and entry of the user-defined code that activates the emergency action.

The present invention permits a user to define an emergency code that is recognizable by a telecommunications system. This advantageously permits a user to covertly signal an emergency and also permits a user to define emergency actions that should be taken for certain emergencies.

Whereas the present invention has been described with respect to specific embodiments thereof, it will be understood that various changes and modifications will be suggested to one skilled in the art and it is intended that the invention encompass such changes and modifications as fall within the scope of the appended claims.

1. A telecommunications switch comprising:
an interface for receiving from a device a predefined activation code that enables a user-defined emergency feature and a user-defined code associated with the user-defined emergency feature;
a subscriber database that stores the user-defined code, the subscriber database being coupled to the interface;
a processor coupled to the interface and the subscriber database that:
receives a dialed number entered at the device;
compares the dialed number with the user-defined code stored in the database;
initiates a pre-selected emergency action if the dialed number matches the user-defined code stored in the database, wherein the pre-selected emergency action includes forwarding the call to an emergency response center; and
treats the call as a normal call if the dialed number does not match the user-defined code stored in the database.

2. The telecommunications switch of claim 1 wherein the subscriber database is a one of a home location register and a visitor location register.

3. The telecommunications switch of claim 1 wherein the interface includes a wireless interface for coupling to wireless devices.

4. The telecommunications switch of claim 1 wherein the interface receives at least one emergency action code that determines a pre-selected emergency action to be taken in response to receipt of a user-defined code.

5. The telecommunications switch of claim 1 wherein the pre-selected emergency action includes playing an audible response and the audible response is one of music, an announcement, and silence.

6. The telecommunications switch of claim 1 wherein the pre-selected emergency action includes monitoring activity associated with device.

7. The telecommunications switch of claim 1 wherein the pre-selected emergency action includes determining and monitoring a location of the device.

8. The telecommunications switch of claim 1 wherein the interface receives a predefined deactivation code that disables the user-defined emergency feature such that if a dialed number is the user-defined code, the call is treated as a normal call.

9. The telecommunications switch of claim 1 wherein the interface receives a pre-defined false-alarm code, wherein in response to receipt of the false alarm code the processor cancels any emergency action taken in response to receiving the user-defined code.

10. The telecommunications switch of claim 1 wherein the pre-selected emergency action is a default emergency action.

11. The telecommunications switch of claim 1 wherein the pre-selected emergency action includes logging at least one of a subscriber number, a time of call, a day of call, and a serving base station.

12. A method for enabling a user to define at least one code for emergency calls in a telecommunications system, the method comprising the steps of:
receiving a predefined activation code that enables a user-defined emergency feature;
receiving a user-defined code associated with the user-defined emergency feature;
storing the user-defined code in a subscriber database;
receiving a dialed number from a device associated with the user;
determining whether the dialed number is the user-defined code stored in the database;
if the dialed number is the user-defined code stored in the database, then applying a pre-selected emergency action; and
if the dialed number is not the user-defined code stored in the subscriber database, then processing continues according to the dialed number.

13. The method of claim 12 further comprising the step of receiving at least one emergency action code that determines a pre-selected emergency action to be taken in response to receipt of a user-defined code.

14. The method of claim 13 wherein the pre-selected emergency action includes determining and monitoring a location of the device associated with the user.

15. The method of claim 12 wherein the pre-selected emergency action includes playing an audible response and the audible response is one of music, an announcement, and silence.

16. The method of claim 12 further comprising the step of receiving a predefined deactivation code that disables the user-defined emergency feature such that if a dialed number is the user-defined code, the call is processed according to the dialed number and no pre-selected emergency action is taken.

17. The method of claim 12 further comprising the step of receiving a pre-defined false-alarm code, wherein receipt of the false alarm code cancels any emergency action taken in response to receiving the user-defined code.

18. The method of claim 12 wherein the pre-selected emergency action includes notifying an emergency response center.
